(19) United States
(12) Patent Application Publication
(10) Pub. No.: US 2005/0180158 A1
(43) Pub. Date: Aug. 18, 2005

(54) Vehicle lamp unit

(75) Inventor: Motohiro Komatsu, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: KOITO MANUFACTURING CO., LTD.

(21) Appl. No.: 11/050,793

(22) Filed: Feb. 7, 2005

(30) Foreign Application Priority Data
Feb. 10, 2004 (JP) P.2004-033397

(51) Int. Cl. B60Q 1/04

(52) U.S. Cl. 362/545; 362/509

(57) ABSTRACT

A pair of upper and lower incidence surfaces are formed on a rear face of a translucent member disposed to cover three light-emitting elements. On upper and lower sides of the incidence surfaces are formed a pair of reflection surfaces for causing light emitted by the light-emitting elements and having entered the translucent member to internally reflect forward. Each of the incidence surfaces is formed from a cylindrical convex-curved surface extending horizontally. Each of the reflection surfaces is formed from a parabolic cylindrical curved surface whose focal line passes through a virtual image point of each of the light-emitting elements formed by the corresponding incidence surfaces. By the above configuration, light emitted by the light-emitting elements is caused to internally reflect in such a manner as to diffuse in the horizontal direction, and not to diffuse in the vertical direction, thereby exiting forward from a pair of exit surfaces.

The present application claims foreign priority under 35 USC 119 based on Japanese Patent Application No. 2004-033397, filed on Feb. 10, 2004, the contents of which is incorporated herein by reference in its entirety, and concurrently with the filing of this U.S. patent application.

### BACKGROUND OF THE INVENTION

1. Technical Field

The present invention relates to a vehicle lamp unit which employs a light-emitting element such as a light-emitting diode as its light source.

2. Background of the Related Art

In recent years, a related art vehicle lamp unit which employs a light-emitting diode as a light source has been often adopted.

In relation to the above, Japanese Patent Publication JP-A-2002-50214 discloses a vehicle lamp unit including a light-emitting diode disposed so as to face forward of the lamp unit, and a translucent member disposed so as to cover the light-emitting diode from the front side thereof.

The vehicle lamp unit is configured such that light emitted by the light-emitting diode and having entered the rear end of the translucent member is guided to a front end face of the translucent member to thus exit from the front end face, whereby the light is radiated forward from the lamp unit through a projection lens disposed in front of the front end face.

In view of enhancement of forward visibility at the time of a vehicle cornering, a vehicle illumination lamp, such as a headlamp, is desirably configured to form a horizontally-elongated light distribution pattern whose horizontal diffusion angle is as large as possible, by light radiation from the illumination lamp.

When the related art vehicle lamp unit disclosed in JP-A-2002-50214 is employed, a utilization rate of the light flux in relation to light from the light-emitting diode can be increased. However, there remains a related art problem, in that a horizontally-elongated light distribution pattern whose horizontal diffusion angle is large cannot be formed by light radiation from the lamp unit.

### SUMMARY OF THE INVENTION

The present invention has been conceived in view of at least the foregoing related art. It is an object of the present invention to provide a vehicle lamp unit which employs a light-emitting element as a light source and which can form a horizontally-elongated pattern whose horizontal diffusion angle is large, in addition to increasing a utilization rate of the light flux in relation to light from the light-emitting element. However, the present invention can also be achieved by solving the other objects, or by solving no objects at all.

The present invention has achieved the above object by means of disposing a translucent member so as to cover a light-emitting element from the front side thereof and by consideration of its surface shape.

More specifically, the vehicle lamp unit according to the present invention is
a vehicle lamp unit having a light-emitting element disposed on an optical axis extending in a front-rear direction of the lamp unit so as to face forward, and a translucent member disposed so as to cover the light-emitting element from a front side thereof, the vehicle lamp unit comprising:
a pair of incidence surfaces for allowing light emitted by the light-emitting element to enter the translucent member are formed on upper and lower sides of the optical axis on a rear face of the translucent member, and a pair of reflection surfaces for causing light emitted by the light-emitting element and having entered the translucent member through the incidence surfaces to internally reflect forward are formed on upper and lower sides of the pair of incidence surfaces on the rear face of the translucent member;
a pair of exit surfaces for causing light emitted by the light-emitting element and having been internally reflected by the pair of reflection surfaces to exit forward from the translucent member are formed on a front face of the translucent member;
each of the incidence surfaces is formed from a substantially cylindrical convex-curved surface extending in a horizontal direction orthogonal to the optical axis; and
each of the reflection surfaces is formed from a substantially parabolic cylindrical curved surface whose focal line passes through a virtual image point of the light-emitting element formed by the corresponding incidence surface and which extends in the horizontal direction orthogonal to the optical axis.

The term “light-emitting element” signifies an element-like light source having a light-emitting section which illuminates essentially in the form of a point, and is not limited to any specific type. For example, a light-emitting diode, a laser diode, or the like can be employed.

The translucent member is not limited to any specific material, so long as it is a member having translucency. For instance, a member formed from a transparent synthetic resin, a member formed from glass, or the like, can be employed.

The pair of incidence surfaces, the pair of reflection surfaces, and the pair of exit surfaces are respectively disposed on upper and lower sides of the optical axis. However, each of the pairs may be formed either vertically symmetrically or vertically asymmetrically with respect to the optical axis.

No specific limitations are imposed on surface shapes of portions on the rear face of the translucent member excluding the pairs of incidence surfaces and exit surfaces.

No specific limitations are imposed on surface shapes of portions on the front face of the translucent member other than the pair of exit surfaces.

As shown in the above configuration, the vehicle lamp unit according to the invention is configured such that the translucent member is disposed so as to cover the light-emitting element—which is disposed on the optical axis extending in the front-rear direction of the lamp unit so as to face forward—from the front side thereof. Accordingly, a utilization rate of the light flux in relation to light from the light-emitting element can be increased.

In addition, on upper and lower sides of the optical axis, the pair of incidence surfaces for causing light emitted by the light-emitting element to enter the translucent member are formed on the rear face of the translucent member. On upper and lower sides of the pair of incidence surfaces are formed the pair of reflection surfaces for causing light emitted by the light-emitting element and having entered the translucent member through the incidence surfaces to internally reflect forward. Each of the incidence surfaces is formed from a substantially cylindrical convex-curved surface extending in a horizontal direction orthogonal to the optical axis. Each of the reflection surfaces is formed from a substantially parabolic cylindrical curved surface whose focal line passes through virtual image points of the light-emitting element formed by the incidence surfaces and which extends in the horizontal direction orthogonal to the optical axis.

Accordingly, light emitted by the light-emitting element and having entered the incidence surfaces can be subjected to internal reflection so as to diffuse in the horizontal direction and not to diffuse in the vertical direction.

On the front face of the translucent member are formed the pair of exit surfaces for causing light which has been internally reflected on the pair of reflection surfaces to exit forward from the translucent member. Even when each of the exit surfaces is formed from a simple shape, such as a flat surface, a horizontally-elongated light distribution pattern whose horizontal diffusion angle is large can be formed from light having exited from the exit surfaces.

As described above, according to the present invention, the vehicle lamp unit—which employs a light-emitting element as a light source—can form a horizontally-elongated light distribution pattern whose horizontal diffusion angle is large, in addition to increasing a utilization rate of the light flux in relation to light from the light-emitting element.

In the above configuration, the light-emitting elements to be disposed may be in number of either one or more than one. However, when a configuration in which a plurality of light-emitting elements are disposed at predetermined intervals in a substantially horizontal direction orthogonal to the optical axis is employed, brightness of the horizontally-elongated light distribution pattern can be increased while the shape of the horizontally-elongated light distribution pattern is maintained substantially unchanged.

In addition, in the above configuration, when at least one of the pair of exit surfaces is formed as a downward-deflection surface for causing light having been internally reflected by the reflection surface and reached the exit surface to exit in a downwardly deflected manner, the following working-effects can be obtained. That is, when only one of the exit surfaces is configured as a downward-deflection surface, two horizontally-elongated light distribution patterns can be formed at positions which are vertically displaced. Furthermore, when both of the exit surfaces are configured as downward-deflection surfaces, the position of the horizontally-elongated light distribution pattern can be displaced downward with the lamp unit being maintained such that the optical axis thereof extends horizontally.

As described above, no particular limitations are imposed on surface shapes of portions other than the pair of exit surfaces on the front face of the translucent member. However, in the case where there is employed a configuration where a grooved space section extending in a horizontal direction orthogonal to the optical axis is formed between the pair of exit surfaces on the front face, there can be realized a novel design of a lamp unit in which two exit surfaces are located at two vertically-separated positions. In addition, another lamp unit or the like can be disposed in the grooved space section.

In the above configuration, when the following configuration is employed, even in a case where the front-rear lengths of the pair of exit surfaces are set short, a utilization rate of the light flux in relation to light from the light-emitting element can be increased. That is, the pair of incidence surfaces are formed at positions which are vertically separated from each other; a portion which is on the rear face of the translucent member and which is between the two incidence surfaces is formed as a second incidence surface for allowing light emitted by the light-emitting element to enter while being deflected close to the optical axis in the vertical direction; a portion which is on the front face of the translucent member and which is between the two exit surfaces is formed as a second exit surface for causing light emitted by the light-emitting element and having entered the translucent member through the second incidence surface to exit forward from the translucent member in such a manner as to diffuse light in the horizontal direction and not to diffuse in the vertical direction. By virtue of the above configuration, the translucent member can be reduced in front-rear length, thereby enabling compact configuration of the lamp unit.

### BRIEF DESCRIPTION OF THE DRAWINGS

FIG. 1 is a front view showing a vehicle illumination lamp according to an exemplary, non-limiting embodiment of the present invention;

FIG. 2 is a cross-sectional view taken along II-II of FIG. 1;

FIG. 3 is a side cross-sectional view showing a lamp unit for forming a base light distribution pattern of the vehicle illumination lamp according to an exemplary, non-limiting embodiment of the present invention;

FIG. 4 is a perspective view showing a lamp unit for forming a widely-spread light distribution pattern of the vehicle illumination lamp according to an exemplary, non-limiting embodiment of the present invention;

FIG. 5 is a front view showing a lamp unit for forming the widely-spread light distribution pattern according to an exemplary, non-limiting embodiment of the present invention;

FIG. 6 is a side cross-sectional view showing the lamp unit for forming the widely-spread light distribution pattern according to an exemplary, non-limiting embodiment of the present invention;

FIG. 7 is a plan cross-sectional view showing the lamp unit for forming the widely-spread light distribution pattern according to an exemplary, non-limiting embodiment of the present invention;

FIG. 8 is a detailed view showing an essential portion of FIG. 6;

FIG. 9 illustrates a perspective view of a low-beam light distribution pattern formed on a virtual vertical screen placed ahead of the lamp, from light radiated forward from the vehicle illumination lamp;

FIG. 10 is a side cross-sectional view showing a lamp unit for forming a widely-spread light distribution pattern according to a first exemplary modification of the exemplary, non-limiting embodiment of the present invention;

FIG. 11 is a side cross-sectional view showing a lamp unit for forming a widely-spread light distribution pattern according to a second exemplary modification of the exemplary, non-limiting embodiment of the present invention;

FIG. 12 is a perspective view of a low-beam light distribution pattern formed on the virtual vertical screen from light radiated forward from the lamp provided with the lamp unit according to the second exemplary modification;

FIG. 13 is a side cross-sectional view showing a lamp unit for forming a widely-spread light distribution pattern according to a third exemplary, modification of the exemplary, non-limiting embodiment of the present invention; and

FIG. 14 is a detailed view showing an essential portion of FIG. 13.

### DETAILED DESCRIPTION OF THE INVENTION

Embodiments of the invention will be described hereinbelow by reference to the drawings.

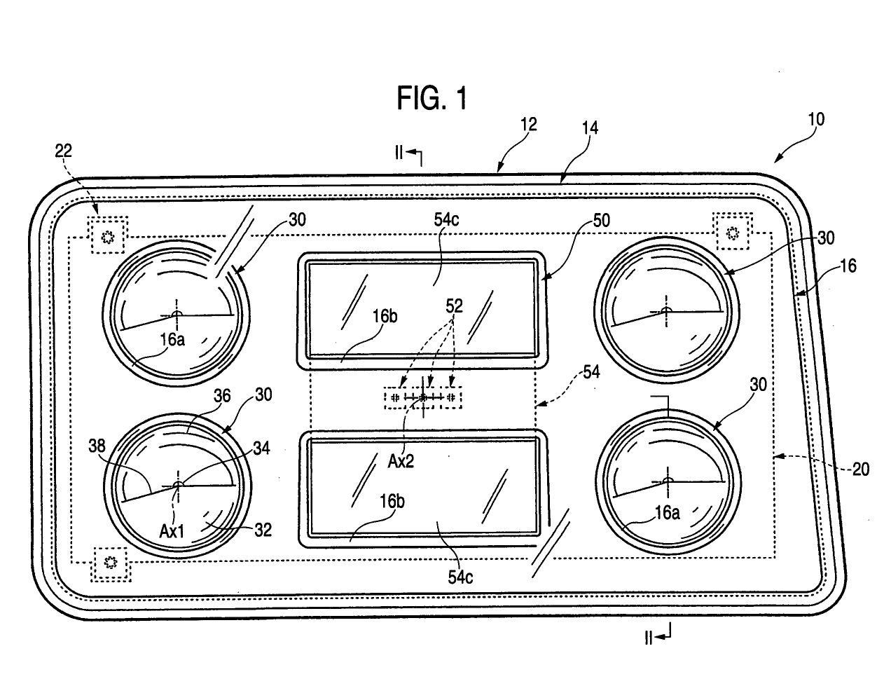

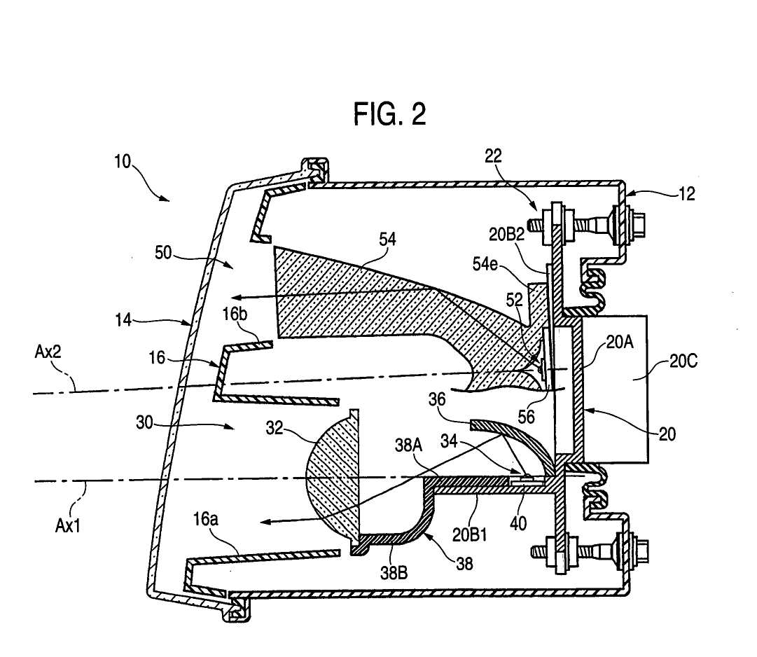

FIG. 1 is a front view showing a vehicle illumination lamp according to an exemplary, non-limiting embodiment of the present invention. FIG. 2 is across-sectional view taken along II-II of FIG. 1. A vehicle illumination lamp 10 is a headlamp disposed on the right side of the front end of a vehicle and configured such that five lamp units 30, 50 are housed within a lamp chamber. The lamp chamber is formed from a lamp body 12 and a clear translucent cover 14 which is attached to a front end opening of the lamp body 12.

Of the five lamp units 30, 50, the four lamp units 30 are set to have an external shape which is substantially circular when viewed from the front, and are disposed in two rows, upper and lower. The remaining, single lamp unit 50 is set to have an external shape which is substantially rectangular when viewed from the front, and is disposed at the center of the four lamp units 30, with two lamp units 30 on the right thereof and the remaining two lamp units 30 on the left thereof.

An inner panel 16 is disposed along the lamp unit 14 in the lamp chamber. Cylindrical openings 16a, 16b are respectively formed in the inner panel 16 at positions corresponding to the respective lamp units 30, 50. In relation to the above, the cylindrical openings 16b corresponding to the lamp unit 50 are formed at two positions which are vertically separated.

When attached to a common unit support member 20, the five lamp units 30, 50 are supported by the lamp body 12 by way of an aiming mechanism 22 to allow tilting in a vertical direction and in a lateral direction.

The unit support member 20 includes a die casting, and comprises a vertical panel section 20A, unit-mounting sections 20B1, 20B2 extending forward from a plurality of positions of the vertical panel section 20A, and a heat sink section 20C formed from a plurality of radiator fins rearwardly extending from the vertical panel section 20A to positions exposed to the space outside of the lamp.

The vehicle illumination lamp 10 is configured such that a low-beam light distribution pattern is formed by light radiation from the five lamp units 30, 50.

Of the five lamp units 30, 50, the four lamp units 30 are lamp units for radiating light for forming a base light distribution pattern of the low-beam light distribution pattern; and the remaining lamp unit 50 is a lamp unit for radiating light for forming a widely-spread light distribution pattern which reinforces the base light distribution pattern.

Optical axes Ax1 of the four lamp units 30 for forming the base light distribution pattern extend in a direction substantially orthogonal to the vertical panel section 20A and parallel to each other. The optical axes Ax1 of the lamp units 30 are set to extend in a direction oriented about 0.5 to 0.60 downwardly with respect to the longitudinal direction of the vehicle upon completion of control of the optical axis by means of the aiming mechanism 22. Meanwhile, the remaining lamp unit 50 is set such that an optical axis Ax2 thereof is oriented slightly downward with respect to the optical axis Ax1 of the lamp units 30.

Next, the specific configurations of the lamp units 30, 50 will be described. First, the specific configuration of the lamp unit 30 for forming the base light distribution pattern will be described.

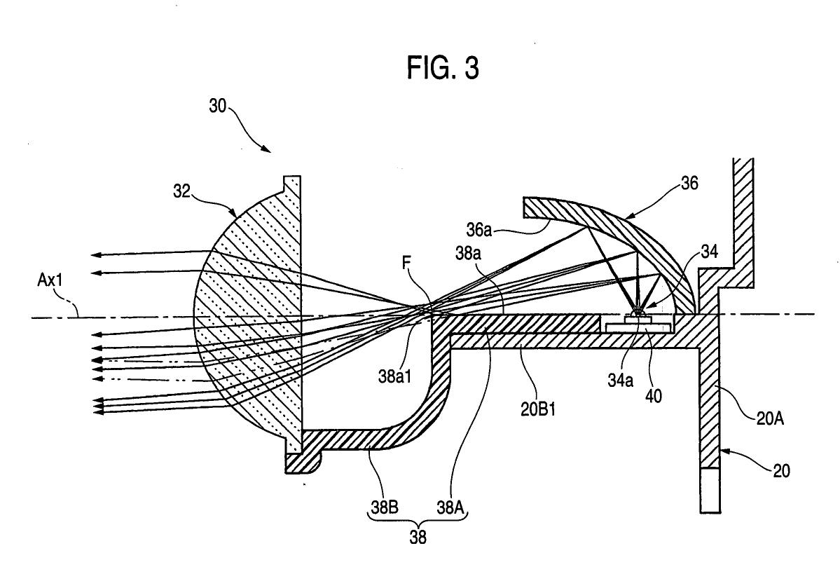

FIG. 3 is a side cross-sectional view showing the lamp unit 30 in detail. As shown in FIG. 3, the lamp unit 30 is a lamp unit of projector type, and comprises a projection lens 32 disposed on the optical axis Ax1, a light-emitting element 34 disposed rearward of the projection lens 32, a reflector 36 disposed so as to cover the light-emitting element from above, and a straight-travel blocking member 38 disposed at a position between the light-emitting element 34 and the projection lens 32.

The projection lens 32 is made of a transparent resin, and is formed from a plano-convex lens having a convex surface on the front surface and a plane surface on the rear surface.

The light-emitting element 34 is a white light-emitting diode having a light-emitting chip 34a measuring about 0.3 to 1 mm square. The light emitting-element 34 is fixed on the unit-mounting section 20B1 on the unit support member 20 with a support plate 40 therebetween in a state such that the light-emitting chip 34a faces vertically upward on the optical axis Ax1.

The reflector 36 is configured so as to reflect light from the light-emitting element 34 forward and close to the optical axis Ax1, thereby substantially converging the light to a point in the vicinity of a rear focal point F of the projection lens 32. More specifically, a reflection surface 36a of the reflector 36 is set such that across-sectional profile including the optical axis Ax1 is substantially elliptical, and such that its eccentricity gradually increases from a vertical cross section to a horizontal cross section. The reflection surface 36a is arranged so as to substantially converge light from the light-emitting element 34 to a point slightly forward of the rear focal point F. The reflector 36 is fixed on the unit-mounting section 20B1 at the peripheral lower end of the reflector 36.

The straight-travel blocking member 38 comprises a main body section 38A whose upper surface 38a is formed into substantially a chevron shape when the lamp is viewed from the front, and a lens holder 38B formed that extends forward from the front end of the main body section 38A.

The upper surface 38a of the main body section 38A extends rearward from the rear focal point F of the projection lens 32, and is formed from a flat surface including a region which is to the left of the optical axis Ax1 (i.e., on the right side when the lamp is viewed from the front) and which extends horizontally to the left from the optical axis Ax1, and a flat surface including a region which is to the right of the optical axis Ax1 and which extends obliquely downward (e.g., downward by an angle of about 15°) to the right from the same. A front edge 38a1 of the upper surface 38a is formed into substantially an arc shape along a focal plane of the rear focal point F of the projection lens 32.

The upper surface 38a is subjected to mirror surface treatment by means of aluminum deposition or the like, thereby configuring the upper surface 38a as a reflection surface. The main body section 38A is configured such that the upper surface 38a prevents a part of light, which is reflected by the reflection surface 36a, from traveling straight forward, thereby reflecting upward. Meanwhile, the main body section 38A is fixed, on its lower surface, to the unit-mounting section 20B1.

The lens holder 38B is configured so as to extend forward from the front end of the main body section 38A in a downwardly curved manner, and supports the projection lens 32 at the front end thereof.

Next, the specific configuration of the lamp unit 50 for forming the widely-spread light distribution pattern will be described.

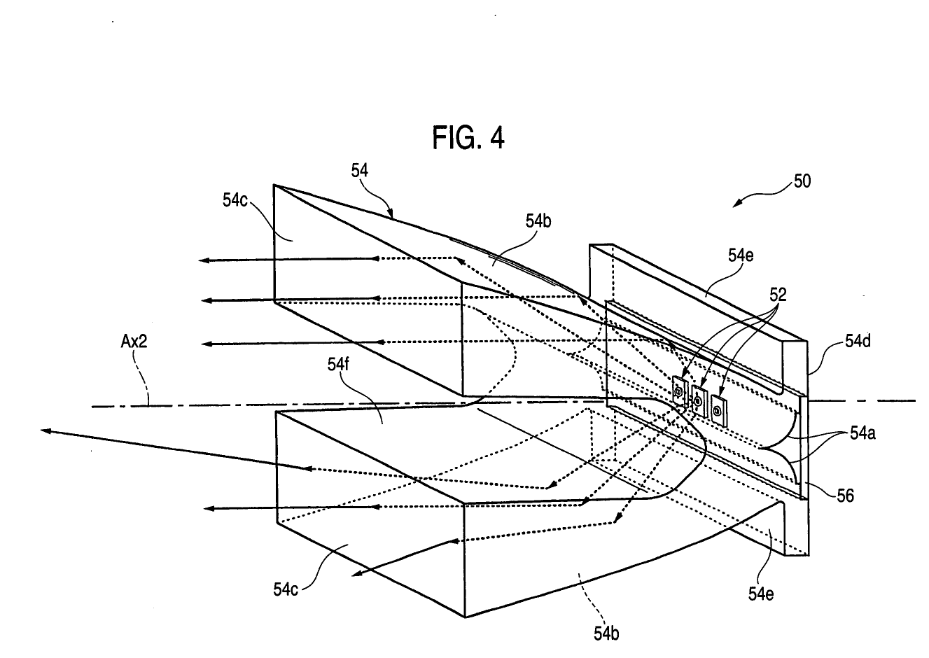

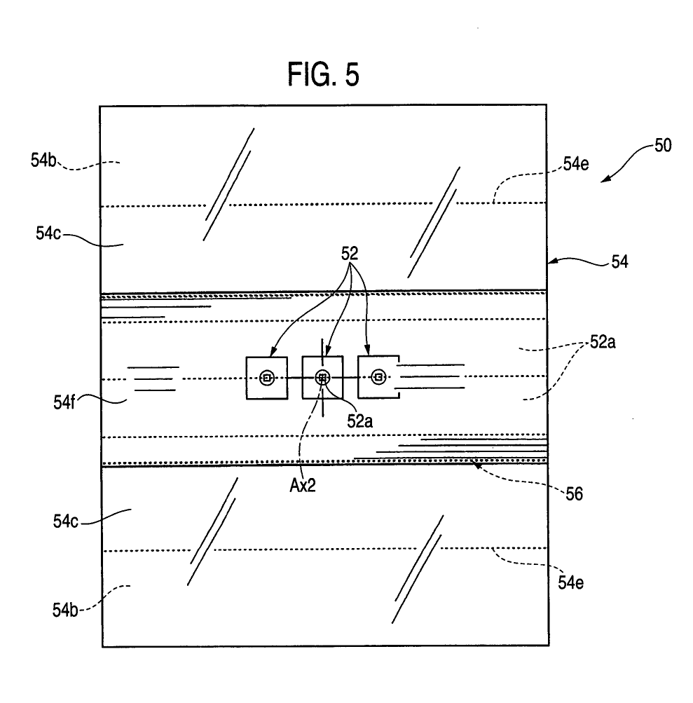

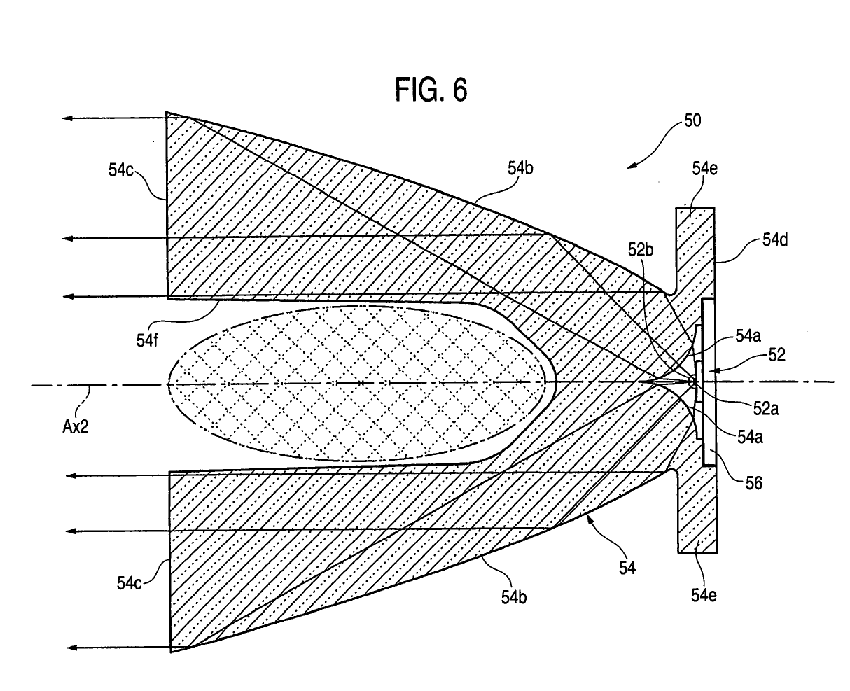

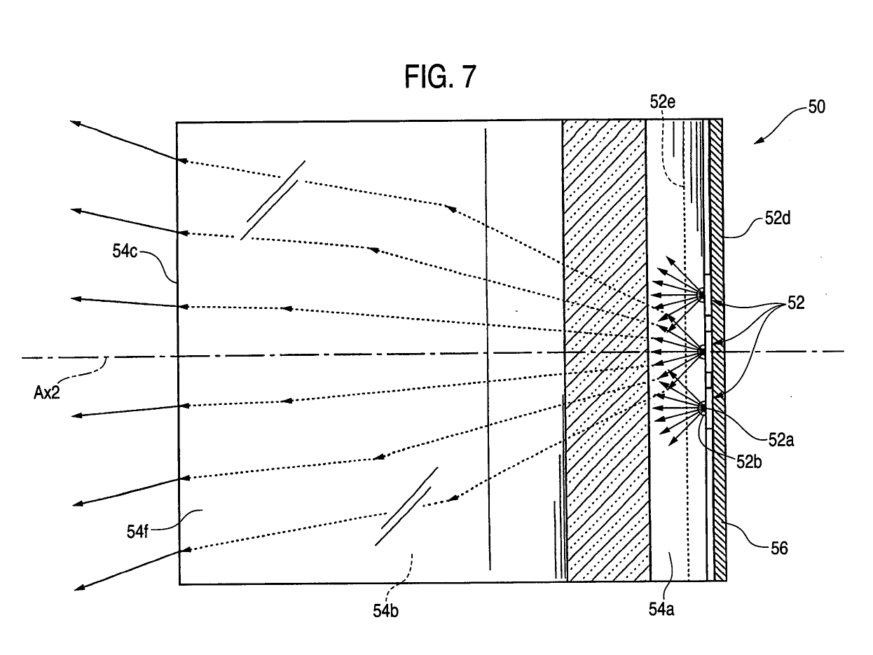

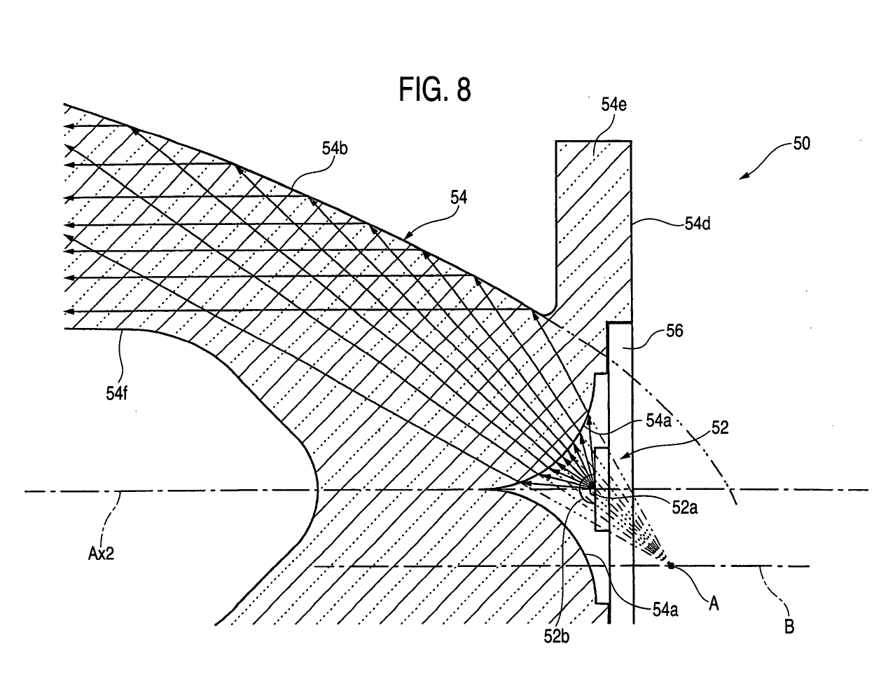

FIG. 4 is a perspective view showing the lamp unit 50 as a single article. FIG. 5, FIG. 6, and FIG. 7 are a front view, a side cross-sectional view, and a plan cross-sectional view, respectively, showing the lamp unit 50 in detail. FIG. 8 is a detailed view showing an essential portion of FIG. 6.

The lamp unit 50 comprises three light-emitting elements 52, a translucent member 54, and a support plate 56.

The three light-emitting elements 52 are disposed at regular intervals and close to each other in the horizontal direction orthogonal to the optical axis Ax2. Each of the light-emitting elements 52 is a white light-emitting diode having a light-emitting chip 52a measuring about 0.3 to 1 mm square, and a hemispherical sealing resin 52b for sealing the light-emitting chip 52a. The light-emitting element 52 is disposed such that the light-emitting chip 52a faces forward on the optical axis Ax2, or on two sides thereof, right and left.

The translucent member 54 is a thick plate block member made of a transparent resin having a substantially-V-shaped lateral side geometry, a substantially rectangular front geometry, and a substantially rectangular plane geometry. The translucent member 54 is disposed so as to cover the light-emitting element 52 from the front side thereof. More specifically, the translucent member 54 is of a vertically symmetric shape with respect to the optical axis Ax2, and set to be about 60 mm in lateral width, about 70 mm in height, and about 80 mm in depth.

The support plate 56 is a metal member, which is flush with a rear end face 54d of the translucent member 54 and which extends in the vertical direction, and fixedly supports the three light-emitting elements 52 at the center of the front face thereof.

The specific configuration of the translucent member 54 is now described. A pair of incidence surfaces 54a for allowing light emitted by the light-emitting elements 52 to enter the translucent member 54 are disposed on two sides, upper and lower, of the optical axis Ax2 on the rear face of the translucent member 54. In addition, a pair of reflection surfaces 54b for causing light emitted by the respective light-emitting elements 52 and having entered the translucent member 54 through the incidence surfaces 54a to internally reflect forward are formed on two sides, upper and lower, of the pair of incidence surfaces 54a on the rear face of the translucent member 54. Furthermore, on the front face of the translucent member 54, there are formed a pair of exit surfaces 54c for causing light emitted by the light-emitting elements 52 and having been internally reflected by the pair of reflection surfaces 54b to exit forward from the translucent member 54.

Each of the incidence surfaces 54 is formed from a cylindrical convex-curved surface extending in a horizontal direction orthogonal to the optical axis Ax2. In addition, each of the reflection surfaces 54b is formed from a parabolic cylindrical curved surface whose focal line passes through a virtual image point A of each of the light-emitting elements 52 formed by the respective incidence surface 52a (more accurately, a virtual image point of the respective light-emitting chip 52a) and which extends in the horizontal direction orthogonal to the optical axis Ax2.

In relation to the above, the parabolic cylindrical curved surface is formed such that the axial plane B of the center axis, which includes the focal line, extends parallel to the optical axis Ax2. By virtue of the above configuration, light emitted by the light-emitting elements 52 and having entered the incidence surfaces 54a is caused to internally reflect such that the light is diffused in the horizontal direction, and is not diffused in the vertical direction.

Each of the reflection surfaces 54b is formed so that an incident angle of light emitted by the light-emitting elements 52 and having impinged on the reflection surface 54b is larger than a critical angle of the translucent member 54. By virtue of this configuration, the internal reflection on the reflection surface 54b always effects total reflection. Accordingly, the surface of the translucent member 54 is not subjected to mirror surface treatment by means of aluminum deposition or the like.

Each of the exit surfaces 54c has an external shape of a horizontally-elongated rectangle, and is formed from a flat surface extending along a vertical plane orthogonal to the optical axis Ax2. By virtue of the above configuration, each of the exit surfaces 54c causes light which has reached the exit surface 54c from the respective reflection surface 54b and has been internally reflected thereon to exit forward from the exit surface 54c as parallel light which has not been diffused in the vertical direction, and is deflected in the horizontal direction to the right and left to thus be further diffused.

A grooved space section 54f, whose cross-sectional profile is a horizontally elongated U-shape and which extends in the horizontal direction orthogonal to the optical axis Ax2, is formed between the pair of exit surfaces 54c on the front face of the translucent member 54. The grooved space section 54f is formed to provide as large a space as possible within the translucent member 54 in a range of a region where light beams emitted from the respective light-emitting elements 52 do not pass through.

As shown in FIG. 2, the lamp unit 50 is fixedly supported on the unit-mounting section 20B2 at a pair of upper and lower flange sections 54e of the translucent member 54 in such a manner that the rear end face of the translucent member 54 and the rear face of the support plate 56 contact the front face of the unit-mounting section 20B2 of the unit support member 20.

The front face of the unit-mounting section 20B2 is constituted from such a flat surface formed by tilting a vertical plane—which is orthogonal to the optical axis Ax2—slightly forward. Accordingly, the optical axis Ax2 of the lamp unit 50 is set to be oriented slightly downward.

As shown in FIG. 1, each of the lamp units 30 is formed such that the projection lens 32 is substantially circular when viewed from the front. Therefore, the cylindrical opening 16a of the inner panel 16, which corresponds to the projection lens 32, is formed into a circular shape to surround the projections lens 32. Meanwhile, the lamp unit 50 is configured such that each of the pair of upper and lower exit surfaces 54c of the translucent member 54 is a horizontally-elongated rectangular when viewed from the front. Therefore, each of the cylindrical openings 16b, which corresponds to the exit surface 54c, is formed into a horizontally-elongated rectangular so as to surround each of the exit surfaces 54c.

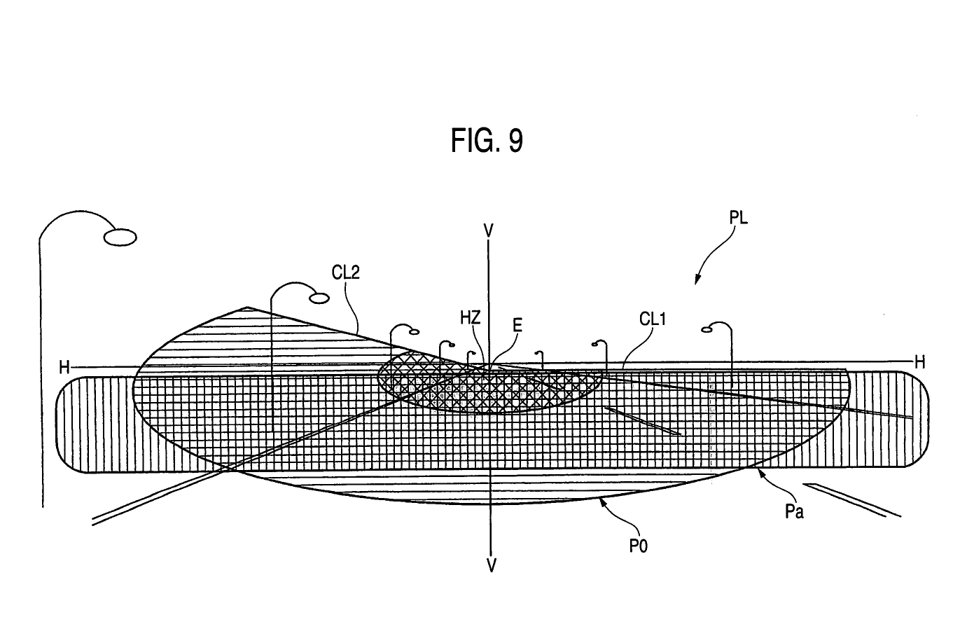

FIG. 9 is a view showing a perspective view of a low-beam light distribution pattern formed on a virtual vertical screen placed at a position 25 m ahead of the lamp, by light radiated forward from the vehicle illumination lamp 10.

As shown in FIG. 9, the low-beam light distribution pattern PL is a light distribution pattern of left-oriented light distribution, having a horizontal cut-off line CL1 and an oblique cut-off line CL2—which rises at a predetermined angle (e.g., approximately 15°) from the horizontal cut-off line CL1—provided at an upper end edge of the low-beam light distribution pattern PL. The position of an elbow point E, which is a point of intersection of the cut-off lines CL1 and CL2, is set to a location situated about 0.5 to 0.6° below a point H-V, a vanishing point in the frontward direction of the lamp. A hot zone HZ, which is a high-intensity region, is formed in the low-beam light distribution pattern PL so as to surround the elbow point E.

The low-beam light distribution pattern PL is formed as a composite light distribution pattern of four base light distribution patterns P0—which are formed by light radiated from the four lamp units 30, at a single location in a superimposed manner—and a widely-spread light distribution pattern Pa which is formed by light radiated from the lamp units 50.

The base light distribution pattern P0 formed by light radiated from the lamp unit 30 forms the horizontal cut-off line CL1 and the oblique cut-off line CL2 as a reverse projection image of the front edge 38a1 of the upper surface 38a of the main body section 38A in the straight-travel blocking member 38. In relation to the above, the upper surface 38a of the main body section 38A is configured as a reflection surface. Therefore, of light reflected by the reflection surface 36a of the reflector 36, light to exit upward from the projection lens 32 is also utilized as light which exits downward from the projection lens 32 as shown by a line consisting of short—and long dashes in FIG. 3. Thereby, a utilization ratio of a luminous flux of the light having exited from the light-emitting element 34 is improved while the hot zone HZ is formed.

Meanwhile, light having exited from the respective exit surfaces 54c of the translucent member 54 of the lamp unit 50 is light that is not diffused with respect to the vertical direction and is widely diffused to the right and left sides with respect to the horizontal direction. Accordingly, a widely-spread light distribution pattern Pa formed by light radiation from the light unit 50 is a horizontally-elongated light distribution pattern which is widely diffused in the lateral direction.

Meanwhile, the upper edge of the widely-spread light distribution pattern Pa is positioned slightly below the horizontal cut-off line CL1. This positioning is due to the optical axis Ax2 of the lamp unit 50 being set to be oriented slightly downward with respect to the optical axis Ax1 of the lamp unit 30.

As described above in detail, the vehicle illumination lamp 10 according to the embodiment includes two types of lamp units 30, 50. Of the lamp units, the lamp unit 50 is configured such that the translucent member 54 is disposed to cover the three light-emitting elements 52, which are disposed facing forward on the optical axis Ax2, from the front side thereof. Accordingly, a utilization rate of the light flux in relation to light from the respective light-emitting elements 52 can be increased.

In addition, on the upper and lower sides of the pair of incidence surfaces 54a, the pair of reflection surfaces 54b for allowing light emitted by the light-emitting element 52 and having entered the translucent member 54 through the incidence surfaces 54a to enter the translucent member 54 are formed on the rear face of the translucent member 54. Each of the incidence surfaces 54a is formed from a cylindrical convex-curved surface extending in a horizontal direction orthogonal to the optical axis Ax2; and each of the reflection surfaces 54b is formed from a parabolic cylindrical curved surface whose focal line passes through a virtual image point A of the light-emitting elements 52 formed by the incidence surfaces 52a and extends in the horizontal direction orthogonal to the optical axis Ax2. Accordingly, light emitted by the light-emitting elements 52 and having entered the incidence surfaces 54a can be caused to internally reflect so as to diffuse in the horizontal direction, and not diffuse in the vertical direction.

On the front face of the translucent member 54, there are formed the pair of exit surfaces 54c for causing light emitted from the light-emitting elements 52 and having internally reflected on the pair of reflection surf aces 54b to exit forward from the translucent member 54. In spite of these exit surfaces 54c being formed from simple vertical flat surfaces, the horizontally-elongated light distribution pattern Pa whose horizontal diffusion angle is large can be formed from light having exited from the exit surfaces 54c.

As described above, according to the exemplary, non-limiting embodiment of the present invention, the horizontally-elongated light distribution pattern Pa whose horizontal diffusion angle is large can be formed from light radiation from the lamp unit 50, while a utilization rate of the light flux in relation to light from the light-emitting element 52 is increased. Accordingly, sufficient brightness of the diffusion region of the low-beam distribution pattern PL can be ensured, thereby enabling enhancement of forward visibility at the time of cornering of a vehicle, and the like.

Particularly in the exemplary, non-limiting embodiment, the three light-emitting elements 52 are disposed at intervals in the horizontal direction orthogonal to the optical axis Ax2. Therefore, the brightness of the horizontally-elongated light distribution pattern Pa can be enhanced, while the shape of the horizontally-elongated light distribution pattern Pa is maintained in substantially the same shape.

In addition, according to the exemplary, non-limiting embodiment, the grooved space section 54f extending in the horizontal direction orthogonal to the optical axis Ax2 is formed between the pair of exit surfaces 54c on the front face of the translucent member 54. Therefore, at least a novel design of a lamp unit in which two exit surfaces 54c are located at two vertically-separated positions can be realized. Furthermore, another lamp unit or the like may be disposed in a space formed inside the grooved space section 54f (that is, a space indicated by a line consisting of long and short dashes in FIG. 6).

In addition, the vehicle illumination lamp 10 is configured such that the projector-type lamp units 30—whose external shape is set to be substantially circular—are disposed in two rows, upper and lower, on both the right and left sides of the lamp unit 50, in which the pair of horizontally-elongated rectangular exit surfaces 54c are exposed at positions which are vertically separated. As a further novel feature, the surface of the projection lens 32 of each of the lamp units 30 can be formed to be substantially spherical. In contrast, each of the exit surfaces 54c of the translucent member 54 of the lamp unit 50 is formed into a flat surface.

In addition, the surface of the translucent member 54 of the vehicle illumination lamp 10 need not be subjected to mirror surface treatment by means of aluminum deposition or the like. Consequently, the configuration of the lamp unit 50 can be simplified.

Meanwhile, the above embodiment has been described on an assumption that a number of the light-emitting elements 52 to be disposed in the lamp unit 50 is three. However, the number of the same can be set to be two, four, or one, as would be understood by one of ordinary skill in the art.

The above embodiment has been described based on the assumption that the translucent member 54 vertically symmetrical in relation to the optical axis Ax2, and set to a size of about 60 mm in lateral width, about 70 mm in height, and about 80 mm in depth. However, as a matter of course, the translucent member 54 can be set to other sizes. In addition, the translucent member 54 can have a vertically-asymmetric shape by means of, for example but not by way of limitation, setting to different values curvatures of the cylindrical surfaces constituting the respective incidence surfaces 54a and focal distances of the parabolic cylindrical surfaces constituting the respective reflection surfaces 54b.

Furthermore, the above embodiment has been described on an assumption that the grooved space section 54f is formed into a shape having across-sectional profile of an elongated U-shape. Alternatively, the grooved space section 54f can be formed so as to have a different cross-sectional profile. For example but not by way of limitation, the entire front face of the translucent member 54 can be formed from a vertical plane flush with the pair of exit surfaces 54c, rather than forming such a grooved space section 54f on the front face of the translucent member 54.

The above embodiment has been described based on the assumption that the axial plane B of the center axis of the parabolic cylindrical curved surface constituting each of the reflection surfaces 54b extends substantially parallel to the optical axis Ax2. However, the axial plane B of the center axis can also be set to extend in a direction tilted with respect to the optical axis Ax2.

In addition, the above embodiment has been described based on the assumption that each of the incidence surfaces 54a is formed from a cylindrical surface, and each of the reflection surfaces 54b is formed from a parabolic cylindrical curved surface. However, even when each of the incidence surfaces 54a is formed not from an accurate cylindrical surface but from an approximate curved surface thereof, or when of the reflection surfaces 54b is formed not from an accurate parabolic cylindrical curved surface but from an approximate curved surface thereof, working-effects substantially analogous to those of the above embodiment can be obtained.

Furthermore, the above embodiment has been described based on the assumption that each of the exit surfaces 54c of the translucent 54 is formed into a flat surface. However, a lens element for lateral diffusion may be formed on each of the exit surfaces 54c. When such a configuration is employed, the lateral diffusion angle of the horizontally-elongated pattern can be further increased.

Also, the above embodiment has been described based on the assumption that the light-emitting chip 34a, 52a of each of the light-emitting elements 34, 52 measures about 0.3 to 1 mm square. However, another size and/or another external shape can be employed. For instance, the light-emitting chips 34a, 52a can be formed into a substantial rectangle, or the like, having a shorter side of 1 mm and a longer side of 2 mm, or alternatively, a shorter side of 1 mm and a longer side of 4 mm.

The vehicle illumination lamp 10 according to the embodiment is configured to include five lamp units 30, 50. However, as a matter of course, the number of the respective lamp units can be set to another number.

The vehicle illumination lamp 10 according to the embodiment has been described on an assumption that the base light distribution pattern P0 of the low-beam light distribution pattern PL is formed by light radiated from the four lamp units 30. However, the base light distribution pattern P0 can be formed from other lamp units.

Meanwhile, the vehicle illumination lamp 10 is configured to house only the lamp units 30, 50 for forming the low-beam light distribution pattern PL within a light chamber thereof. However, as a matter of course, there can be employed a configuration in which lamp units for forming a high-beam light distribution pattern are also included in the light chamber.

The vehicle illumination lamp 10 has been described based on the assumption that the vehicle illumination lamp 10 is a head lamp disposed on the right side of the front end of a vehicle. However, effects substantially analogous to those of the above embodiment can also be obtained from a vehicle illumination lamp other than a headlamp, such as a fog lamp, by means of adopting a configuration similar to that of the above-mentioned embodiment.

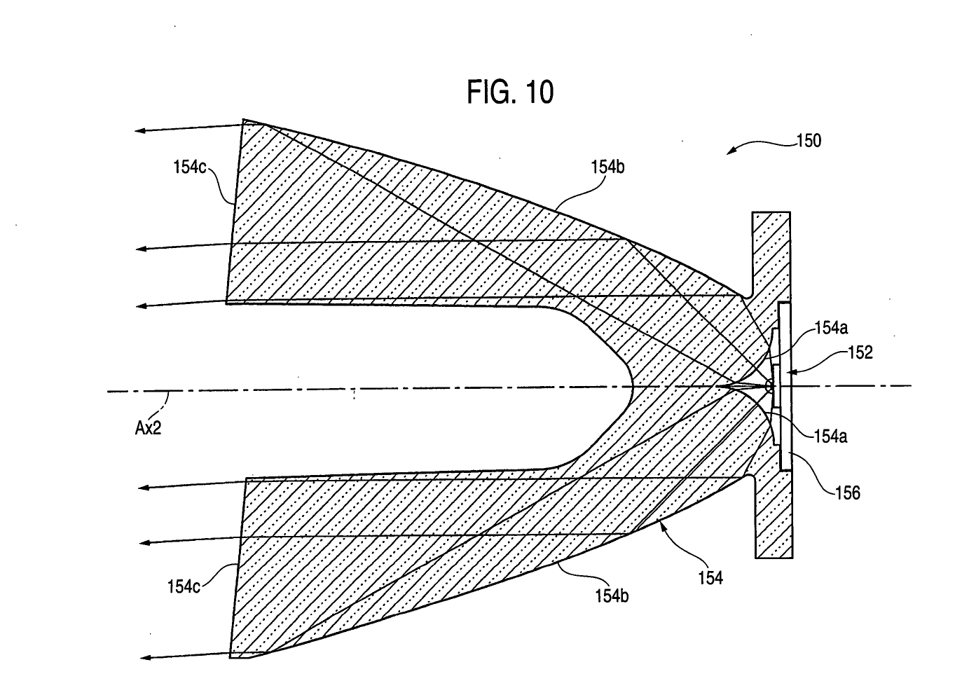

Next, a first exemplary modification of the exemplary, non-limiting embodiment of the present invention will be described. FIG. 10 is a side cross-sectional view showing a lamp unit 150 for forming a widely-spread light distribution pattern according to the first exemplary modification. The lamp unit 150 comprises three light-emitting elements 152, a translucent member 154, and a support plate 156.

The light-emitting elements 152 and the support plate 156 are completely analogous in configuration with the light-emitting elements 52 and the support plate 56 of the lamp unit 50.

The translucent member 154 differs from the translucent member 54 of the lamp unit 50 in that each of the exit surfaces 154c of the translucent member 154 is formed as a downward deflection surface. However, other configurations are analogous to those of the translucent member 54.

Each of the exit surfaces 154c of the translucent member 154 is formed with a flat surface tilted slightly rearward in relation to a vertical plane orthogonal to the optical axis Ax2. By virtue of the above configuration, light having reached the exit surfaces 54c from the reflection surfaces 54b and having been internally reflected thereon exits forward from the exit surface 154c in a downwardly deflected manner.

When the configuration of the first exemplary modification is employed, a horizontally-elongated light distribution pattern with a large horizontal diffusion angle can be formed from light radiation from the lamp unit 150 while increasing a utilization rate of the light flux in relation to light from the light-emitting elements 152.

Furthermore, the modification is arranged such that light having reached the exit surfaces 154c from the reflection surfaces 154b and having been internally reflected thereon is caused to exit forward from the exit surface 154c in a downwardly deflected manner. Accordingly, even when the lamp unit 150 is disposed such that the optical axis Ax2 thereof extends horizontally, the horizontally-elongated light distribution pattern can be formed at a desired position by means of downwardly displacing a position where the horizontally-elongated light distribution pattern is formed. By virtue of this configuration, the mounting structure of the lamp unit 150 onto the unit support member 20 can be simplified.

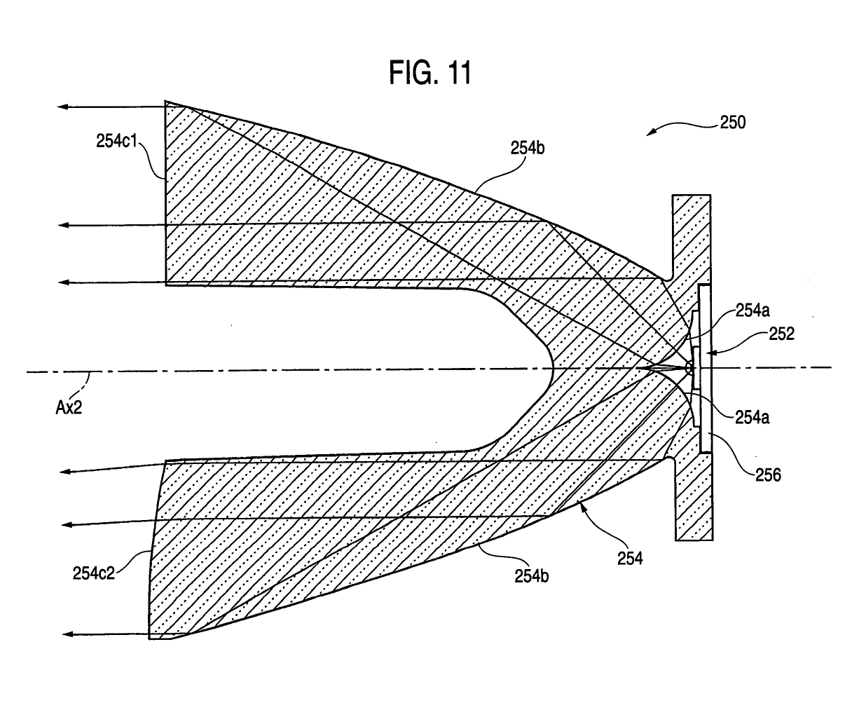

Next, a second exemplary modification of the exemplary, non-limiting embodiment will be described. FIG. 11 is a side cross-sectional view showing a lamp unit 250 for forming a widely-spread light distribution pattern. The lamp unit 250 comprises three light-emitting elements 252, a translucent member 254, and a support plate 256.

The light-emitting elements 252 and the support plate 256 are analogous in configuration with the light-emitting elements 52 and the support plate 56 of the lamp unit 50.

The translucent member 254 differs from the translucent member 54 of the lamp unit 50 in that, of a pair of exit surfaces 254c1, 254c2 of the translucent member 254, the exit surface 254c2 on the lower side is formed as a downward-deflection surface. However, the exit surface 254c1 on the upper side is completely analogous in configuration with the translucent member 54, and elements other than that are completely analogous in configuration with those of the translucent member 54.

The exit surface 254c2 of the translucent member 254 is formed from a substantially cylindrical surface. The cylindrical surface assumes a circular-arc cross-sectional profile when taken along a vertical plane, the profile being curved so as to wrap from the lower edge of the exit surface 254c2 toward the upper edge of the same and rearward from the vertical plane, and extends in the horizontal direction orthogonal to the optical axis Ax2. By this configuration, light having reached the exit surface 254c from the reflection surface 254b and having been internally reflected thereon is caused to exit forward from the exit surface 254c while being diffused to a direction oriented downward from the horizontal by an angle.

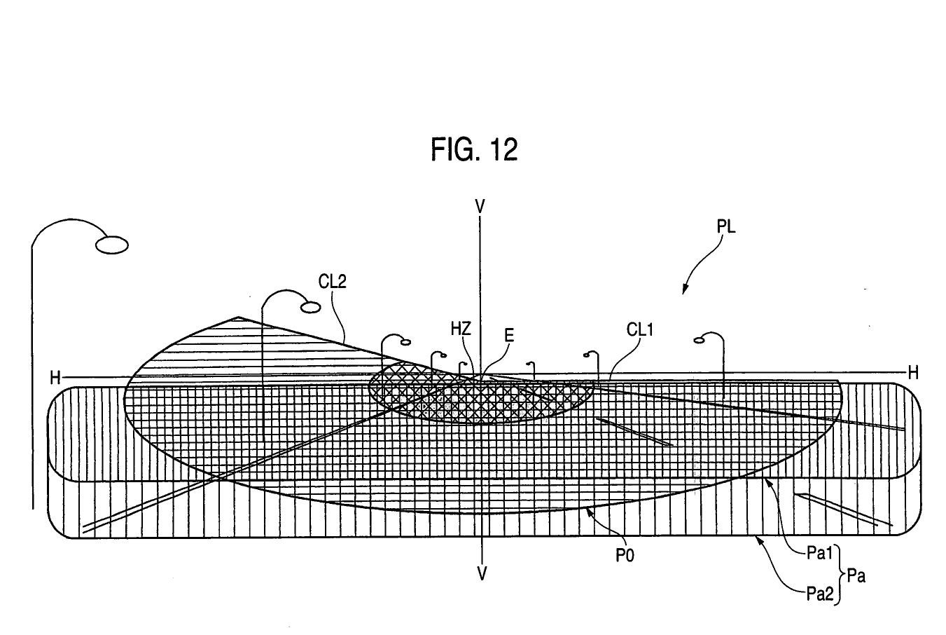

FIG. 12 is a view showing a perspective view of a low-beam light distribution pattern formed on the virtual vertical screen by means of light radiated forward from the vehicle illumination lamp 10 provided with the lamp unit 250 according to the second exemplary modification of the present invention. The low-beam light distribution pattern PL is formed as a composite light distribution pattern of the four base light distribution patterns P0—which are formed by light radiated from the four lamp units 30 on a single location in a superimposed manner—and the widely-spread light distribution pattern Pa which is formed by light radiated from the lamp units 250. The widely-spread light distribution pattern Pa is formed as a composite light distribution pattern of a light distribution pattern Pa1 formed from light having exited from the exit surface 254c1 and another light distribution pattern Pa2 formed from light having exited from the exit surface 254c2.

The light distribution pattern Pa1 is substantially identical in shape with the widely-spread light distribution pattern Pa formed from light radiated from the lamp unit 50 of the above-mentioned exemplary embodiment. However, the light distribution pattern Pa2 is a light distribution pattern shaped such that the light distribution pattern Pa1 is expanded downward. The reason for this shape is that the light having exited from the exit surface 254c2 is diffused in a direction downward from the horizontal by the angle.

When the configuration of the exemplary modification is employed, the horizontally-elongated light distribution pattern Pa having a large horizontal diffusion angle can be formed from light radiated from the lamp unit 250 while increasing a utilization rate of the light flux in relation to light from the light-emitting element 252.

In addition, the exemplary modification is arranged such that the widely-spread light distribution pattern Pa is formed as a composite light distribution pattern of the light distribution pattern Pa1 and the light distribution pattern Pa2 having a shape such that the light distribution pattern Pa1 is expanded downward. Accordingly, the occurrence of an uneven light distribution on the widely-spread light distribution pattern Pa can be prevented. In addition, since the low-beam light distribution pattern PL can be formed as a light distribution pattern that brightly illuminates a road a head of the vehicle including a vicinity region thereof, further enhancement of forward visibility is enabled.

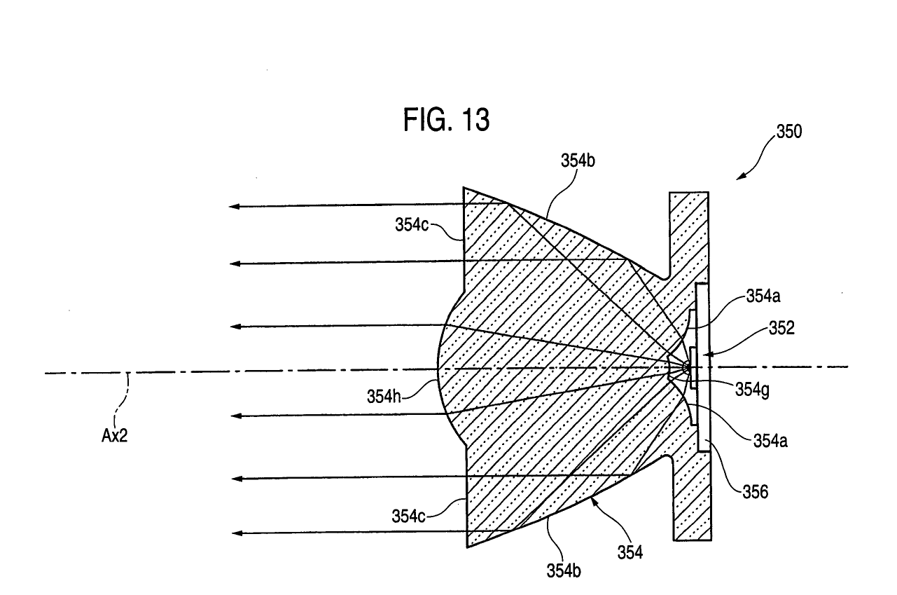

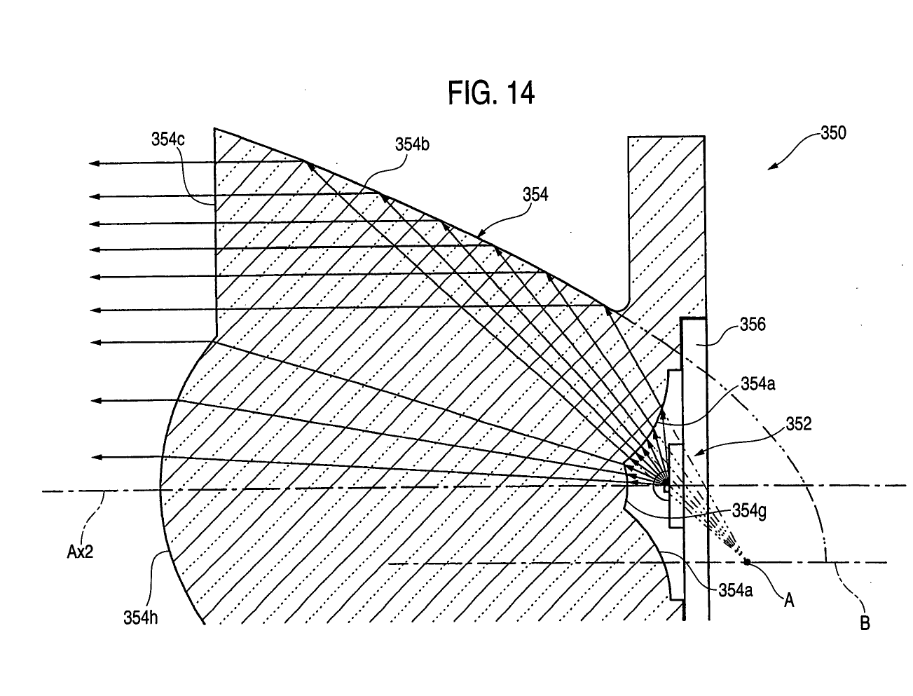

Next, a third exemplary, non-limiting modification of the present invention will be described. FIG. 13 is a side cross-sectional view showing a lamp unit 350 for forming a widely-spread light distribution pattern according to the third exemplary modification. FIG. 14 is a detailed view of the essential portion of FIG. 13. The lamp unit 350 comprises three light-emitting elements 352, a translucent member 354, and a support plate 356. The light-emitting elements 352 and the support plate 356 are analogous in configuration with the light-emitting elements 52 and the support plate 56 of the lamp unit 50.

The translucent member 354 is configured such that a pair of incidence surfaces 354a are formed at positions vertically separated from each other, and a portion on the rear face of the translucent member 354 and between the two incidence surfaces 354a is constituted as a second incidence surface 354g. In relation to the above, each of the incidence surfaces 354a is formed into such a shape that, when compared to the incidence surfaces 54a of the translucent member 54, a portion close to the optical axis Ax2 is cut away; and light passing through the thus-cut portion is directed to the second incidence surface 354g. The second incidence surface 354a is formed from a cylindrical convex-curved surface extending in a horizontal direction orthogonal to the optical axis Ax2 so that light emitted from each of the light-emitting elements 354 enters the translucent member 354 while being deflected substantially close to the optical axis Ax2.

Each of a pair of reflection surfaces 354b of the translucent member 354 has a shorter front-rear length than the pair of reflection surfaces 54b of the translucent member 54. The reason for the above is as follows. I

In the above-mentioned embodiment, light has impinged on a front region of each of the reflection surfaces 54b from a portion of the corresponding incidence surface 54a close to the optical axis Ax2 in the translucent member 54. However, as a result of formation of the second incidence surface 354g, light is no longer present in that region, thereby negating the front region.

A portion which is on the front face of the translucent member 354 and which is between a pair of exit surfaces 354c is formed as a second exit surface 354h. The second exit surface 354h is formed from a cylindrical convex-curved surface extending in a horizontal direction orthogonal to the optical axis Ax2 so that light emitted from the light-emitting element 352 and having entered the translucent member 354 through the second incidence surface 354g is caused to exit forward from the translucent member 354 in such a manner as to diffuse in the horizontal direction and not to diffuse in the vertical direction.

Also, when the configuration of the modification is employed, a horizontally-elongated light distribution pattern having a large horizontal diffusion angle can be formed from light radiated from the lamp unit 350 while increasing a utilization rate of the light flux in relation to light from the light-emitting element 352.

Furthermore, the modification enables an increase in a utilization rate of the light flux in relation to light from each of the light-emitting elements 52 in spite of the front-rear length of each of the reflection surfaces 354b being set to a small value. Accordingly, the translucent member 354 can be reduced in front-rear length to thus miniaturize the lamp unit 350.

While the invention has been described above with reference to the embodiment, the technical range of the invention is not restricted to the range described in the embodiment. It is apparent to the skilled in the art that various changes or improvements can be made in the embodiment. It is apparent from the appended claims that the embodiment thus changed or improved can also be included in the technical range of the invention.

1. A vehicle lamp unit having at least one light-emitting element disposed on an optical axis extending forward and in a front-rear direction of the lamp unit, and a translucent member disposed so as to cover the light-emitting element at a front side of said light emitting element, comprising:
a pair of incidence surfaces that allow light emitted by the light-emitting element to enter the translucent member, formed on upper and lower sides of the optical axis on a rear face of the translucent member;
a pair of reflection surfaces for internally forward reflecting said emitted light having entered the translucent member through the pair of incidence surfaces; and
a pair of exit surfaces that cause forward exiting of said emitted light and internally reflected by the pair of reflection surfaces from the translucent member, formed on a front face of the translucent member,
wherein each of the incidence surfaces comprises a substantially cylindrical convex-curved surface extending in a horizontal direction orthogonal to the optical axis, and
each of the reflection surfaces comprises a substantially parabolic cylindrical curved surface having a focal line that passes through a virtual image point of the light-emitting element, said substantially parabolic cylindrical curved surface formed by a corresponding one of the incidence surfaces, and extending in the horizontal direction orthogonal to the optical axis.

2. The vehicle lamp unit according to claim 1, wherein
a plurality of the at least one light-emitting element are disposed in the horizontal direction orthogonal to the optical axis at intervals.

3. The vehicle lamp unit according to claim 1, wherein
at least one of the pair of exit surfaces is a downward-deflection surface that causes the internally reflected light to exit in a downwardly deflected manner.

4. The vehicle lamp unit according to claim 1, wherein
a grooved space section extending in the horizontal direction orthogonal to the optical axis is formed between the pair of exit surfaces on the front face of the translucent member.

5. The vehicle lamp unit according to claim 1, wherein
the pair of incidence surfaces are vertically separated from each other, and a portion thereof on the rear face of the translucent member and between the two incidence surfaces comprises another incidence surface that allows said emitted light to enter while being deflected close to the optical axis in a vertical direction; and
a portion between the pair of exit surfaces on the front face of the translucent member comprises another exit surface that causes forward exiting of said emitted light, having entered the translucent member through the second incidence surface, to exit forward from the translucent member in a diffused manner in the horizontal direction and not in the vertical direction.

6. A lamp disposed on a vehicle in a forward direction, comprising:
at least one first lamp unit of a first type, configured to generate a base light distribution pattern; and
at least one second lamp unit of a second type, configured to generate a horizontally elongated light distribution pattern having a large horizontal distribution angle, said at least one second lamp unit comprising,
a first light emitting element that emits light, and
a translucent member that covers a front said of said first light-emitting element.

7. The lamp of claim 6, wherein said at least one first lamp unit has a substantially circular external shape, and said at least one second lamp unit has a substantially rectangular external shape.

8. The lamp of claim 6, wherein said at least one first lamp unit is a projector lamp unit having a second light emitting element that emits light, a reflector that reflects that emitted light in a forward direction, and a projection lens that transmits said light in said forward direction.

9. The lamp of claim 6, where said at least one second lamp unit comprises:
a pair of incidence surfaces that allow light emitted by the first light-emitting element to enter the translucent member, formed on upper and lower sides of the optical axis on a rear face of the translucent member;
a pair of reflection surfaces for internally forward reflecting said emitted light having entered the translucent member through the pair of incidence surfaces; and
a pair of exit surfaces that cause forward exiting of said emitted light and internally reflected by the pair of reflection surfaces from the translucent member, formed on a front face of the translucent member,
wherein each of the incidence surfaces comprises a substantially cylindrical convex-curved surface extending in a horizontal direction orthogonal to the optical axis, and
each of the reflection surfaces comprises a substantially parabolic cylindrical curved surface having a focal line that passes through a virtual image point of the light-emitting element, said substantially parabolic cylindrical curved surface formed by a corresponding one of the incidence surfaces, and extending in the horizontal direction orthogonal to the optical axis.

10. The lamp according to claim 9, wherein
a plurality of the at least one light-emitting element are disposed in the horizontal direction orthogonal to the optical axis at intervals.

11. The lamp according to claim 9, wherein
at least one of the pair of exit surfaces is a downward-deflection surface that causes the internally reflected light to exit in a downwardly deflected manner.

12. The lamp according to claim 9, wherein
a grooved space section extending in the horizontal direction orthogonal to the optical axis is formed between the pair of exit surfaces on the front face of the translucent member, and does not permit said emitted light to pass through.

13. The vehicle lamp of claim 12, wherein said grooved space has a horizontally-elongated U-shape cross-sectional profile and extends orthogonal to the optical axis.

14. The lamp according to claim 9, wherein
a section substantially flush with, and between, said pair of exit surfaces, is formed that does not permit said emitted light to pass through.

15. The vehicle lamp unit according to claim 9, wherein
the pair of incidence surfaces are vertically separated from each other, and a portion thereof on the rear face of the translucent member and between the two incidence surfaces comprises another incidence surface that allows said emitted light to enter while being deflected close to the optical axis in a vertical direction; and
a portion between the pair of exit surfaces on the front face of the translucent member comprises another exit surface that causes forward exiting of said emitted light, having entered the translucent member through the second incidence surface, to exit forward from the translucent member in a diffused manner in the horizontal direction and not in the vertical direction.

16. The lamp of claim 6, wherein said translucent member comprises a thick plate block member that is a transparent resin having a substantially V-shaped lateral side geometry, a substantially rectangular front geometry, and a substantially rectangular plane geometry.
